(19) United States
(12) Patent Application Publication
(10) Pub. No.: US 2025/0158382 A1
(43) Pub. Date: May 15, 2025

(54) ELECTRONIC CIRCUIT BREAKER AND COMPUTER PROGRAM FOR SAME

(71) Applicant: WAGO Verwaltungsgesellschaft mbH, Minden (DE)

(72) Inventors: Daniel NEB, Espelkamp (DE); Vitali KUHN, Ronnenberg (DE)

(73) Assignee: WAGO Verwaltungsgesellschaft mbH, Minden (DE)

(21) Appl. No.: 18/943,858

(22) Filed: Nov. 11, 2024

(30) Foreign Application Priority Data
Nov. 10, 2023 (DE) 10 2023 131 249.9

(51) Int. Cl. H02H 3/04; H02H 1/00; H02H 3/08

(52) U.S. Cl. CPC H02H 3/04; H02H 1/0007; H02H 3/08

(57) ABSTRACT

An electronic circuit breaker having multiple separate output channels, at each of which an electrical output voltage for connecting at least one load is provided. In each case at least one control element, to be manually activated by a user, and at least one display element are associated with an output channel. The nominal current of an output channel is settable via the at least one control element. The maximum output current of the output channel, i.e., the maximal allowable current that can be provided to a load by the output channel, is defined by the set nominal current. A computer program is also provided for such a circuit breaker.

This nonprovisional application claims priority under 35 U.S.C. § 119(a) to German Patent Application No. 10 2023 131 249.9, which was filed in Germany on Nov. 10, 2023, and which is herein incorporated by reference.

### BACKGROUND OF THE INVENTION

### Field of the Invention

The invention relates to an electronic circuit breaker having multiple separate output channels, at each of which an electrical output voltage for connecting at least one load is provided, wherein in each case at least one control element, to be manually activated by a user, and at least one display element are associated with an output channel, the nominal current of an output channel being settable via the at least one control element. The maximum output current of the output channel, i.e., the maximal allowable current that can be provided to a load by the output channel, is defined by the set nominal current. The invention further relates to a computer program for such a circuit breaker.

### Description of the Background Art

Multichannel electronic circuit breakesr, which are known, for example, from the device series 787-1668 of the present applicant, divides the output-side load current over the multiple separate output channels and reliably monitors them for overload and short-circuiting. When an overload or short circuit is detected, the circuit breaker can separately switch off the particular affected output channel. The electronic circuit breaker thus has the functionality of multiple electronic fuses, similarly to FI switches.

### SUMMARY OF THE INVENTION

It is therefore an object of the invention to provide a further improved electronic circuit breaker and an advantageous computer program for the same.

For an electronic circuit breaker, this object is achieved in that the circuit breaker has a warning function via which a warning signal may be displayed to a user, immediately after adjustment of at least one control element by means of at least one display element of the circuit breaker, when the sum of the nominal currents, set for the output channels by means of the control elements, is greater than a maximum allowable current of the circuit breaker. The invention has the advantage that, due to the warning function at the very beginning of the installation or initialization of the circuit breaker, the user checks whether critical load situations may arise during subsequent operation that could result in an exceedance of the maximum allowable current of the circuit breaker. Thus, such a problematic situation is recognized not during ongoing operation when it occurs, as in the prior art, but instead is recognized in advance when the electronic circuit breaker is set by the user by means of the control elements. Monitoring thus already takes place during the initial, and therefore load-free, installation of the circuit breaker, so that even before the controlled operation starts, an overload situation resulting from incorrect nominal current settings by the user may be reliably prevented.

With such circuit breakers it is possible that the maximal allowable device nominal load, established by the components of the input electronics, via which the maximum allowable current of the circuit breaker may be defined, is smaller than the sum of the maximum nominal loads that are settable at the individual output channels, since often, not all output channels are set to the maximum value of the nominal load that is to be set by the control element.

The warning function may be implemented by an appropriate hardware circuit of the circuit breaker, for example an analog circuit or a digital circuit. In one advantageous embodiment, the warning function may be implemented by an appropriate computer program that is executed on a computer of a control device of the circuit breaker. The control device of the circuit breaker may be configured, for example, to control the individual output channels of the circuit breaker.

Whenever reference is made in the present patent application to a display element, this may involve an optical, acoustic, and/or haptic display element. In the case of an optical display element, this may involve, for example, a light display such as an LED. The circuit breaker may be equipped with light displays that are configured to output light signals in different colors.

The warning signal may be displayed, for example, on any given display element of the circuit breaker, for example on a display device used to display error states.

In the normal operating state of the circuit breaker, all output channels are switched on. When an overload or a short circuit is detected on an output channel, the particular output channel may be switched off. No output voltage is then provided to a switched-off output channel.

The warning signal can be output on a display element of the output channel whose control element was most recently activated. This has the advantage that in a simple manner the user is immediately informed of the position of the setting of the control element that has resulted in triggering of the warning signal. Accordingly, the user may also quickly respond to select a permissible configuration of the electronic circuit breaker, for example by appropriately readjusting the control element or some other control element.

The warning function can be configured to no longer output the warning signal when the sum of the nominal currents, set for the output channels by means of the control elements, is no longer above the maximum allowable current. Accordingly, the user is likewise immediately informed when the situation triggering the warning signal is no longer present, for example because the user has adjusted a control element into a position that reduces the nominal current of an output channel.

When a warning signal is initially output, the mentioned switching off of the warning signal may take place immediately or with a certain delay, for example to achieve hysteresis between two switching states.

The warning function can be configured to switch off at least one output channel of the circuit breaker when the sum of the nominal currents, set for the output channels by means of the control elements, is greater than a maximum allowable current of the circuit breaker, so that the sum of the nominal currents of the output channels that are still switched on is below the maximum allowable current. As a result of switching off the output channel, the circuit breaker is protected from an overload situation, i.e., a situation in which the sum of the currents flowing across the output channels is greater than the maximum allowable current of the circuit breaker.

The output channel whose control element was most recently activated can be switched off. This has the advantage that the operability of the other output channels is not impaired.

The warning function can be configured to again switch on the at least one switched-off output channel when the sum of the nominal currents, set for the output channels by means of the control elements, is no longer above the maximum allowable current. The output channel is reactivated in this way. The activation, similarly as for the switching on and off of the warning signal, may take place immediately or with a delay, for example to achieve hysteresis between the switching states.

The circuit breaker can have at least four output channels or at least eight output channels. A plurality of electronically fused load branches in an electrical installation may thus be achieved by use of a circuit breaker.

The circuit breaker can be configured to output a warning signal by means of at least one display element of the circuit breaker, and/or to limit the output current of the output channel to the nominal current and/or to switch off the output channel, when the output current of the output channel exceeds the nominal current that is set by the control element for the output channel. The electronic fuse function of the circuit breaker, i.e., monitoring for overload and short circuiting and the appropriate response, may be implemented in this way. The appropriate response, i.e., outputting a warning signal or limiting the nominal current or switching off the output signal, may take place immediately after the event occurs. In one advantageous embodiment, the response takes place not immediately after the event occurs, but, rather, only after a defined triggering time. The triggering time may be a fixed time period. The triggering time may also be determined based on the amount by which the output current of the output channel exceeds the set nominal current. For small exceedances a fairly long triggering time may be determined, and for larger exceedances a shorter triggering time may be determined.

The circuit breaker can have at least one supply voltage input, the circuit breaker being configured to provide an input voltage, supplied at the supply voltage input, to at least one output channel as an output voltage. The circuit breaker may provide the input voltage, supplied at the supply voltage input, in particular also to multiple or all output channels. The circuit breaker thus acts as a load distribution device via which the input voltage may be distributed over multiple connected loads. The input voltage may be provided, for example, by a power supply unit that is connected to the circuit breaker, or, if the circuit breaker has multiple supply voltage inputs, the input voltage may be provided by multiple power supply units that are connected to the circuit breaker.

A respective output channel can have at least one electronic switching element via which the output voltage may be selectively switched on or off. This allows the particular output channel to be switched off reliably and quickly. In addition, an electronic switching element has the advantage that, compared to mechanical switching elements, it is wear-free and thus allows numerous switching operations.

The object stated at the outset is further achieved by a computer program for a circuit breaker of the above-mentioned type, which includes commands that cause the circuit breaker to carry out a warning function having the following features: (a) checking the condition of whether the sum of the nominal currents, set for the output channels by means of the control elements, is greater than a maximum allowable current of the circuit breaker; (b) if the condition according to feature a) is met, displaying a warning signal by means of at least one display element of the circuit breaker; and/or (c) otherwise, not displaying the warning signal.

The advantages explained above may be achieved here as well. The computer program may be executed on a computer of the circuit breaker. For example, the computer program may be stored in a memory that is installed in the circuit breaker.

At least one output channel of the circuit breaker can be switched off when the sum of the nominal currents, set for the output channels by means of the control elements, is greater than a maximum allowable current of the circuit breaker, so that the sum of the nominal currents of the output channels that are still switched on is below the maximum allowable current. The circuit breaker is thus protected from damage due to overload.

The circuit breaker may have a current monitoring circuit for each output channel, by means of which the output current that is supplied via the output channel is detected and evaluated. If the output current exceeds the nominal current that is set for the output channel by means of the control element, the explained function for protection from overload and short circuiting may become active by switching off the output channel after the triggering time.

The circuit breaker may also have further control elements. Thus, for example, a further control element, for example a button via which a switched-off output channel may be switched on again, may be associated with each output channel. The circuit breaker may also have a signal contact for each output channel, via which a switched-off output channel may be switched on again by feeding an appropriate signal.

The circuit breaker can have a prewarning function via which a prewarning signal is displayable to a user, during ongoing operation of the circuit breaker, by means of at least one display element of the circuit breaker when the output current of the output channel exceeds a prewarning current value that is below the set nominal current. For example, the prewarning current value may be set at 90% of the set nominal current. In this way, the user is signaled of an imminent overload of the output channel, even before the circuit breaker function of the particular output channel, i.e., the electronic fuse, is triggered. Accordingly, the user may initiate countermeasures early before the output channel is switched off.

The circuit breaker can have a load management function via which the capacitances of capacitive loads connected to the output channels is detected, and based on the detected capacitive loads a time-delayed or time-offset switching on of the output channels takes place. In this way, load peaks caused by the capacitive loads may be precluded.

In general, each output channel can be configured to be operated separately and independently of the other output channels. According to one advantageous embodiment of the invention, the circuit breaker has a parallel mode in which two or more channels are configured as a shared output for supplying a load that is connected to these output channels. These output channels operated in parallel mode are thus connected in parallel. The parallel circuit may be implemented within the circuit breaker. In one advantageous embodiment, the parallel circuit is implemented by a corresponding parallel interconnection of the output terminals of the respective output channels; i.e., the hardware parallel circuit is implemented outside the circuit breaker by the user.

To activate the parallel mode, for example a manual control element of the circuit breaker may be appropriately activated. The setting of the nominal current then takes place by setting at least one manual control element, which applies for output channels interconnected in parallel mode.

The circuit breaker may have a monitoring function which monitors whether a particular output current is supplied to a load via all output channels that are interconnected in parallel mode. By use of the monitoring function, it may be checked in particular whether the output channels connected in parallel are loaded essentially symmetrically with output current. For example, for a slightly asymmetrical loading of the output channels, initially a prewarning is output, and for higher asymmetrical loading the output channels connected in parallel are switched off.

The mentioned functions may likewise be implemented as computer programs of the circuit breaker.

A computer may be configured to execute a computer program, for example in the sense of software. The computer may be designed as a standard computer, for example as a PC, laptop, notebook, tablet, or smart phone, or as a microprocessor, microcontroller, or FPGA, or as a combination of such elements.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an electronic circuit breaker in a schematic illustration; and

FIG. 2 shows a housing side of the electronic circuit breaker according to FIG. 1.

### DETAILED DESCRIPTION

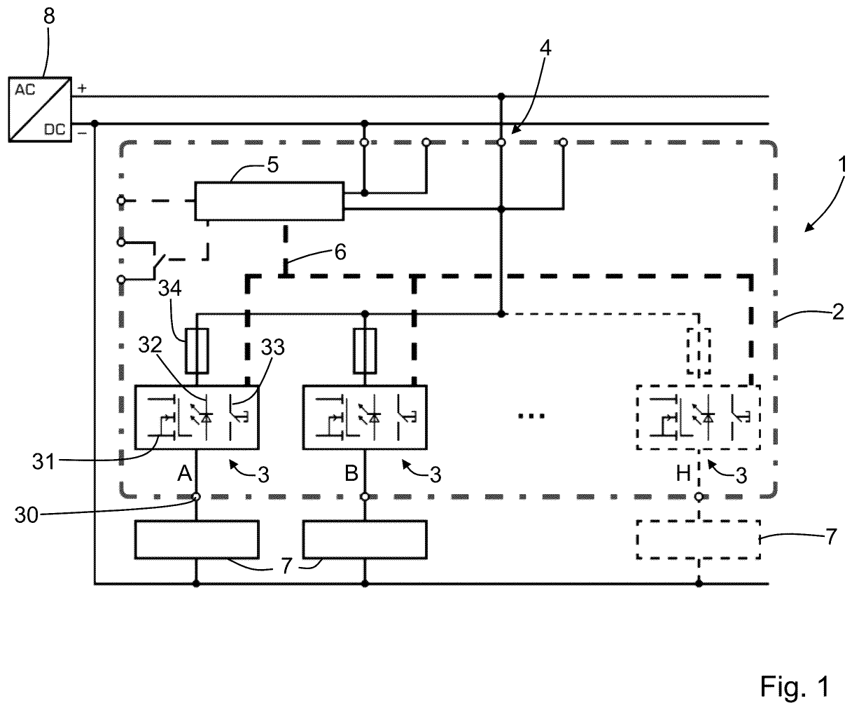

The electronic circuit breaker 1 illustrated in FIG. 1 has a housing 2 that accommodates a circuit arrangement. The circuit arrangement has multiple separate output channels A, B, . . . H, collectively denoted by reference numeral 3. Each output channel may have, for example at a wall of the housing 2, an output terminal 30 at which the output voltage of the output channel 3 is provided. For example, the output terminals 30 may each have a spring-loaded clamping connection for connecting electrical conductors, for example using push-in technology. In particular, the spring-loaded clamping connections may be designed as tension spring connections.

Each output channel may include an electronic switching element 31, a display element 32, and a manual control element 33, for example. In addition, each output channel 3 may include a fuse 34.

The circuit breaker 1 also has a supply voltage input 4, for example in the form of multiple electrical connections mounted on the housing 2, for supplying an input voltage. The circuit arrangement of the circuit breaker 1 also includes a control device 5, which may have a computer via which a computer program is executed. The control device 5 is connected to the individual circuit components of the output channels 3 via lines 6. The control device 5 may switch the switching elements 31 and the display elements 32 on and off via the lines 6. In addition, via the lines 6 the control device 5 may query the particular activation positions of the control elements 33. The circuit arrangement has further components that are not depicted in greater detail in the schematic illustration in FIG. 1, for example a current monitoring circuit for each output channel 3.

FIG. 1 shows that the circuit breaker 1 with its supply voltage input 4 is connected to a power supply unit 8 that provides direct voltage as input voltage. Respective loads 7 are connected to the output terminals 30 of the output channels 3. The loads 7 are thus supplied with input voltage, provided at the supply voltage input 4, via the circuit breaker 1.

The computer of the control device 5 executes a computer program that contains the warning function described above.

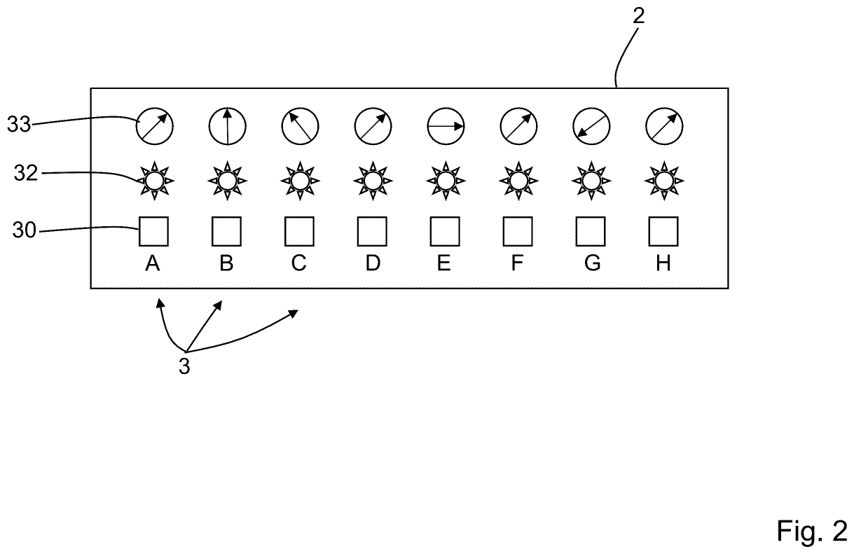

FIG. 2 shows a side of the housing 2 at which the respective output terminals 30, display elements 32, and control elements 33 of the output channels 3 are grouped in such a way that they may also be easily optically associated with a respective output channel 3. In FIG. 2, the output channels 3 are additionally provided with the letters A, B, C, D, E, F, G, H for differentiation. It is apparent that the control elements 33, which may be designed as multistep rotary switches, for example, and which are used for setting the nominal current, are set in different positions by a user.

As an example, it is assumed that the circuit breaker 1 is designed for a maximum allowable current of 70 amperes. The eight output channels 3 discernible in FIG. 2 may each be set to nominal current values of up to 10 amperes via the control elements 33. Thus, if all output channels 3 were set to the maximum nominal current of 10 amperes, 80 amperes could correspondingly be withdrawn, which is above the maximum allowable current of the circuit breaker 1.

It is now assumed that the user sets three output channels 3 to a nominal current of 10 amperes, and sets the remaining five output channels 3 to a nominal current of 8 amperes. This corresponds in sum to a nominal current of 70 amperes, which thus does not yet result in an exceedance of the maximum allowable current of 70 amperes. If the user now adjusts the control element 33 of an output channel 3, which was previously set to 8 amperes, for example, to 10 amperes, this would result in an exceedance of the maximum allowable current of 70 amperes. The warning function implemented in the circuit breaker 1 recognizes this immediately upon adjustment of the control element 33, and signals this to the user by outputting a warning signal on the display element 32 associated with the output channel 3, whose control element 33 was most recently set to 10 amperes, for example by illuminating a display light in red. In addition, the associated output channel 3 may be switched off by switching off its electronic switching element 31, so that the output terminal 30 is no longer supplied with voltage.

If the nominal current is now decreased by activating one or more multiple control elements 33 at one or more of the output channels 3, so that the nominal currents in sum no longer exceed the value of 70 amperes, the previously switched-off output channel 3 is once again switched on. The output of the warning signal on the display element 32 is ended.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electronic circuit breaker comprising:
at least two separate output channels, at each of which an electrical output voltage for connecting at least one load is provided, wherein in each case at least one control element to be manually activated by a user, and at least one display element are associated with an output channel, a nominal current of an output channel being settable via the at least one control element; and
a warning function via which a warning signal is displayed to a user immediately after adjustment of the at least one control element by at least one display element of the circuit breaker, when a sum of the nominal currents, set for the output channels by the control elements is greater than a maximum allowable current of the circuit breaker.

2. The circuit breaker according to claim 1, wherein the warning signal is output on a display element of the output channel whose control element was most recently activated.

3. The circuit breaker according to claim 1, wherein the warning function is configured to no longer output the warning signal when the sum of the nominal currents, set for the output channels by the control elements, is no longer above the maximum allowable current.

4. The circuit breaker according to claim 1, wherein the warning function is configured to switch off at least one output channel of the circuit breaker when the sum of the nominal currents, set for the output channels by the control elements, is greater than a maximum allowable current of the circuit breaker, so that the sum of the nominal currents of the output channels that are still switched on is below the maximum allowable current.

5. The circuit breaker according to claim 4, wherein the output channel whose control element was most recently activated is switched off.

6. The circuit breaker according to claim 4, wherein the warning function is configured to again switch on the at least one switched-off output channel when the sum of the nominal currents, set for the output channels by the control elements is no longer above the maximum allowable current.

7. The circuit breaker according to claim 1, wherein the circuit breaker has at least four output channels or at least eight output channels.

8. The circuit breaker according to claim 1, wherein the circuit breaker is configured to output a warning signal by means of at least one display element of the circuit breaker, and/or to limit the output current of the output channel to the nominal current and/or to switch off the output channel, when the output current of the output channel exceeds the nominal current that is set by the control element for the output channel.

9. The circuit breaker according to claim 1, wherein the circuit breaker has at least one supply voltage input, the circuit breaker being configured to provide an input voltage, supplied at the supply voltage input, to at least one output channel as an output voltage.

10. The circuit breaker according to claim 1, wherein a respective output channel has at least one electronic switching element via which the output voltage is selectively switched on or off.

11. A computer program for a circuit breaker according to claim 1, the computer program comprising commands that cause the circuit breaker to carry out a warning function having the following features:
a) checking the condition of whether the sum of the nominal currents, set for the output channels by the control elements is greater than a maximum allowable current of the circuit breaker;
b) if the condition according to feature a) is met, displaying a warning signal via at least one display element of the circuit breaker; and/or
c) otherwise, not displaying the warning signal.

12. The computer program according to claim 11, wherein at least one output channel of the circuit breaker is switched off when the sum of the nominal currents, set for the output channels by the control elements is greater than a maximum allowable current of the circuit breaker, so that the sum of the nominal currents of the output channels that are still switched on is below the maximum allowable current.
